(19) United States
(12) Patent Application Publication
(10) Pub. No.: US 2009/0093171 A1
(43) Pub. Date: Apr. 9, 2009

(54) PROBE

(75) Inventor: Ted Ju, Keelung (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD, Keelung (TW)

(21) Appl. No.: 12/167,501

(22) Filed: Jul. 3, 2008

(30) Foreign Application Priority Data
Oct. 9, 2007 (CN) 200710030767.9

(51) Int. Cl. H01R 13/24

(52) U.S. Cl. 439/824

(57) ABSTRACT

The invention discloses a probe comprising a first terminal, a second terminal, and a resilient member. The first terminal comprises at least one first connecting portion and a first contact portion, wherein the first connecting portion has a first stop portion. The second terminal comprises at least one second connecting portion and a second contact portion, wherein the second connecting portion has a second stop portion, and the first stop portion of the first terminal is configured in the second stop portion of the second terminal. The resilient member is disposed between the first contact portion and the second contact portion. When the first contact portion of the first terminal or the second contact portion of the second terminal is compressed, the first stop portion of the first terminal can move with respect to the second stop portion of the second terminal.

### BACKGROUND OF THE INVENTION

1. Field of the Invention

The invention relates to a probe and, more particularly to a connecting device which utilizes the probe.

2. Description of the Prior Art

Connecting device is applied to an integrated circuit before a die is packed for functional testing by utilizing a probe and sifting out defective products, and then carries out packing process. The probe is made resilient to keep a certain contact stress, which contacts each testing point of a circuit board closely to make tester accomplish proper electrical test.

Please refer to FIG. 1 and FIG. 2. FIG. 1 is a schematic diagram illustrating a probe 1 of the prior art; FIG. 2 is a schematic diagram illustrating another probe 2 of the prior art. As shown in FIG. 1, the probe 1 comprises a tube 10, an end of the tube 10 connects and integrates a fixed pinpoint 12, the other end is a floating pinpoint 14, and internal of the tube 10 disposes a spring 16. As shown in FIG. 2, both ends of a tube 20 on probe 2 connect floating pinpoints 22 and 24, and internal of the tube 20 disposes a spring 26.

No matter it is conventional probe 1 or probe 2, two disadvantages exist in each case: (1) it is hard to pack; (2) the cost is higher. The scope of the invention is to provide a probe and a connecting device which utilizes the probe, so as to solve the aforesaid problems.

### SUMMARY OF THE INVENTION

A scope of the invention is to provide a probe which is easy to pack and lower in cost.

The invention provides a probe comprises a first terminal, a second terminal and a resilient member. The first terminal comprises at least one first connecting portion, a first contact portion and a first stop portion, wherein the first stop portion is formed on the first connecting portion for limiting the first connecting portion. The second terminal comprises at least one second connecting portion, a second contact portion and a second stop portion, wherein the second stop portion is formed on the second connecting portion for limiting the second connecting portion. The first stop portion of the first terminal is configured in the second stop portion of the second terminal. The resilient member is disposed between the first contact portion of the first terminal and the second contact portion of the second terminal.

The present invention further provides a connecting device comprising a base having a plurality of first holes, at least one probe, each probe is part-slidingly disposed in the corresponding first hole respectively. Each probe respectively comprises a first terminal, a second terminal and a resilient member. The first terminal comprises at least one first connecting portion and a first contact portion, wherein the first connecting portion has a first stop portion for limiting the first connecting portion. The second terminal comprises at least one second connecting portion and a second contact portion, wherein the second connecting portion has a second stop portion for limiting the second connecting portion. The resilient member is disposed between the first contact portion and the second contact portion.

In this embodiment, when the first contact portion of the first terminal or the second contact portion of the second terminal is compressed, the first stop portion of the first terminal can move with respect to the second stop portion of the second terminal.

In this embodiment, both the first connecting portion of the first terminal and the second connecting portion of the second terminal are plate-shaped. The first and second terminals are bent molding under sheet metal mode. Furthermore, the first stop portion of the first terminal and the second stop portion of the second terminal are punching molding under punching mode. Accordingly, the probe of the invention is not only simpler to manufacture and lower in cost, but also easier to be packed.

The advantage and spirit of the invention may be understood by the following recitations together with the appended drawings.

### BRIEF DESCRIPTION OF THE APPENDED DRAWINGS

FIG. 1 is a schematic diagram illustrating a probe of the prior art.

FIG. 2 is a schematic diagram illustrating a probe of the prior art.

FIG. 3 is an appearance view illustrating a probe according to an embodiment of the invention.

FIG. 4 is an exploded view illustrating a part of a probe shown in FIG. 3.

FIG. 5 is a schematic diagram illustrating a probe contacts an electrode or a tin ball.

FIG. 6 is an appearance view illustrating a probe according to another embodiment of the invention.

FIG. 7 is an appearance view illustrating a connecting device which utilizes the probe shown in FIG. 3.

FIG. 8 is a rear view illustrating a connecting device shown in FIG. 7.

FIG. 9 is an appearance view illustrating a probe according to another embodiment of the invention.

FIG. 10 is an appearance view illustrating a probe according to another embodiment of the invention.

FIG. 11 is an appearance view illustrating a connecting device which utilizes the probe shown in FIG. 10.

FIG. 12 is a cross-sectional view illustrating a connecting device along line X-X shown in FIG. 11.

FIG. 13 is an appearance view illustrating a connecting device which removes a first housings shown in FIG. 11.

### DETAILED DESCRIPTION OF THE INVENTION

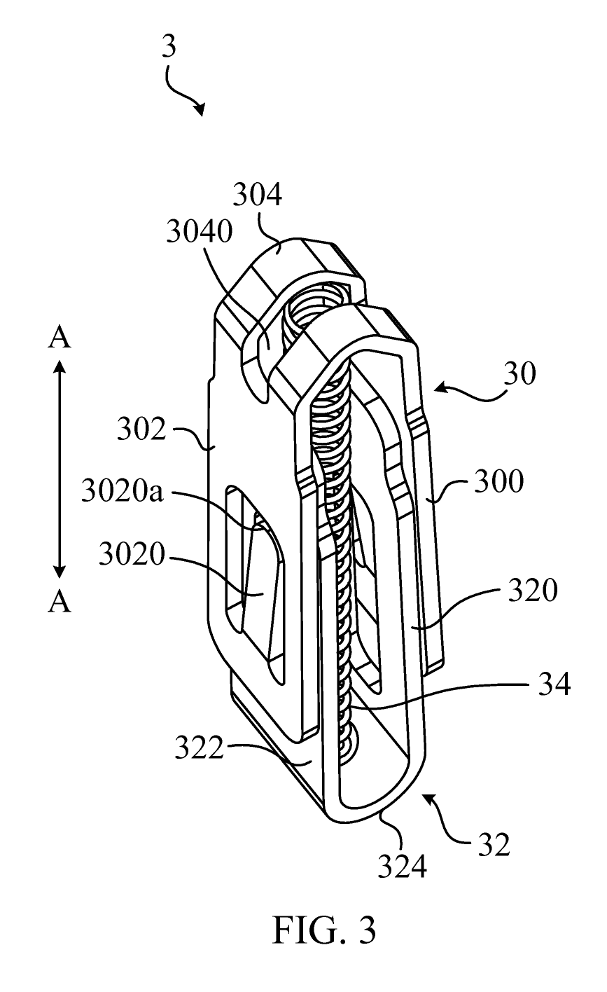

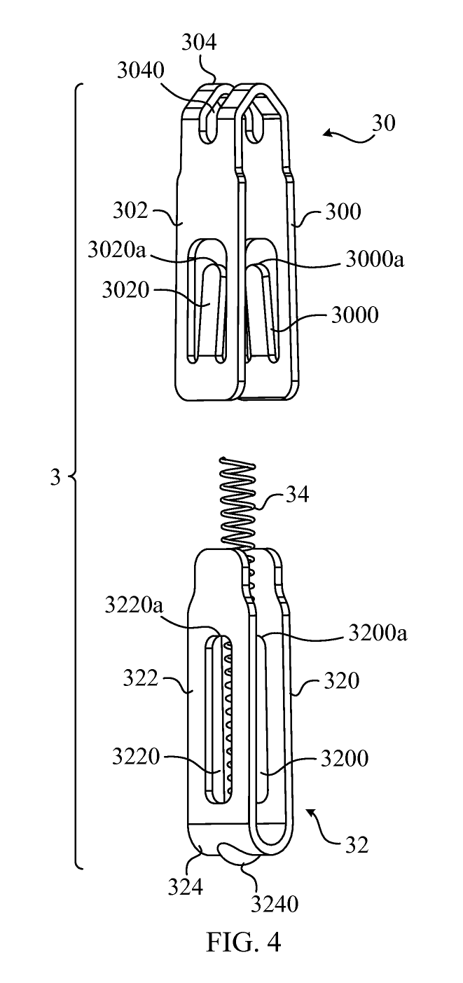

Please refer to FIG. 3 and FIG. 4. FIG. 3 is an appearance view illustrating a probe 3 according to an embodiment of the invention; FIG. 4 is an exploded view illustrating a part of a probe 3 shown in FIG. 3.

A probe 3 of the invention comprises two terminals 30, 32 and a resilient member 34. The terminal 30 comprises two connecting portions 300, 302 and a contact portion 304, wherein the connecting portion 300 has a stop portion 3000, the connecting portion 302 has a stop portion 3020, and the connecting portions 300 and 302 are plate-shaped. The terminal 32 comprises two connecting portions 320 and 322, a contact portion 324 and two stop portions 3200 and 3220, wherein the connecting portions 320 and 322 are plate-shaped. The stop portion 3200 is formed on the connecting portion 320 for limiting the connecting portion 320. The stop portion 3220 is formed on the connecting portion 322 for limiting the connecting portion 322. In this embodiment, the stop portions 3200 and 3220 are cannelures as shown in FIG. 4, though not limited to this.

In this embodiment, the stop portions 3000 and 3020 of the terminal 30 are configured in the stop portions 3200 and 3220 of the terminal 32. Because the stop portion 3000 slightly slants inward, as the terminal 30 is assembled with the terminal 32, a top edge 3000a of the stop portion 3000 will press against a top edge 3200a of the stop portion 3200, and makes it unable to move upward. Similarly, a top edge 3020a of the stop portion 3020 will press against a top edge 3220a of the stop portion 3220, and makes it unable to move upward.

The resilient member 34 is disposed between the contact portion 304 of the terminal 30 and the contact portion 324 of the terminal 32. In practical applications, the resilient member 34 can be a spring or other similar devices.

When the contact portion 304 of the terminal 30 or the contact portion 324 of the terminal 32 is compressed, the stop portions 3000 and 3020 of the terminal 30 can move along a direction of double-arrow A-A shown in FIG. 3 with respect to the stop portion 3200 and 3220 of the terminal 32.

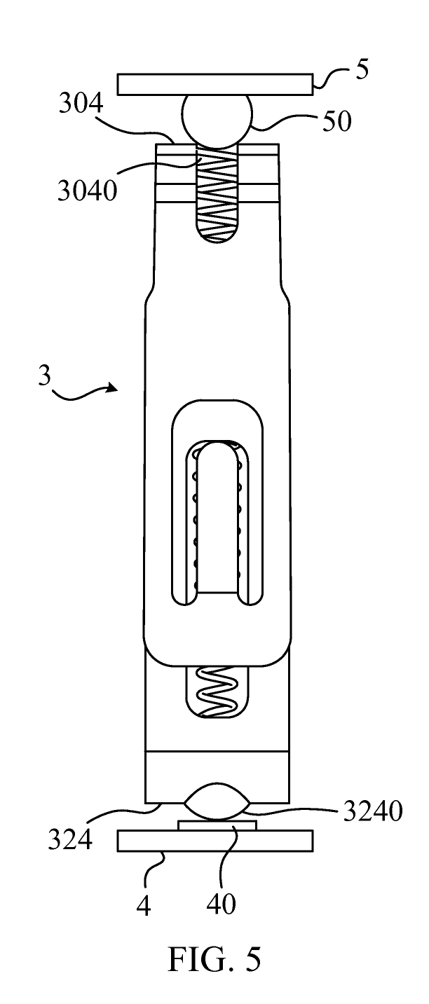

In this embodiment, the contact portion 304 of the terminal 30 has an opening 3040, and the contact portion 324 of the terminal 32 has a protrusion 3240. Please refer to FIG. 5. FIG. 5 is a schematic diagram illustrating a probe 3 contacting an electrode 40 or a tin ball 50. For instance, the opening 3040 of the terminal 30 can clip the tin ball 50 on a circuit board 5 to make electrical tests more precise. Furthermore, the electrode 40 of an electrical component 4 can contact the protrusion 3240 of the terminal 32.

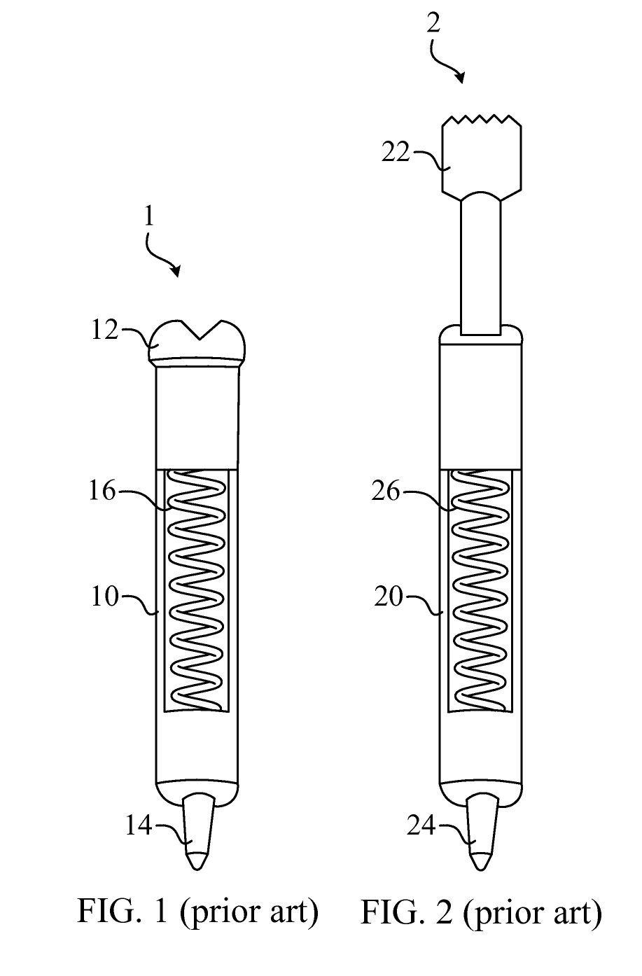

In this embodiment, the terminal 30 and the terminal 32 are molded under sheet metal mode. Furthermore, the stop portions 3000 and 3020, the opening 3040 of the terminal 30 and the stop portions 3200 and 3220 of the terminal 32 are molded under punching mode. Compared with the conventional probes 1 and 2 shown in FIG. 1 and FIG. 2, the probe 3 of the invention is not only simpler to manufacture but is also lower in cost. In addition, because the terminals 30 and 32 have lateral resilience after bending, so it will be easier to assemble.

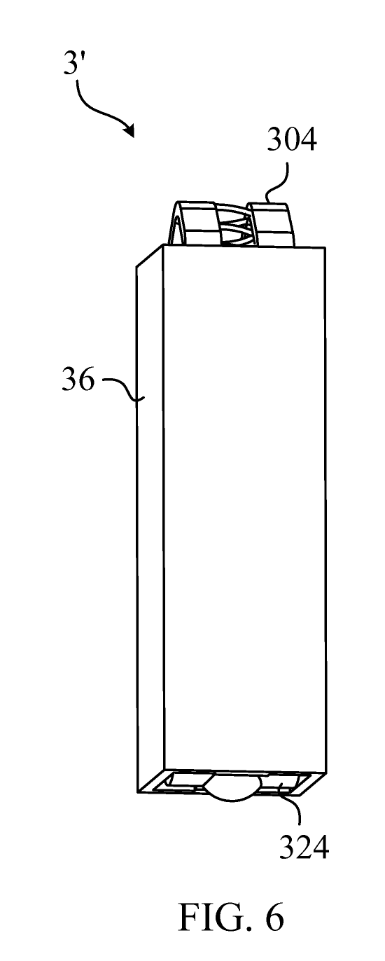

Please refer to FIG. 6. FIG. 6 is an appearance view illustrating a probe 3′ according to another embodiment of the invention. The main difference between the probe 3′ and the probe 3 is that the probe 3′ further comprises an insulating shell 36. The terminal 30, the terminal 32 and the resilient member 34 are accommodated in the insulating shell 36, while the contact portion 304 of the terminal 30 and the contact portion 324 of the terminal 32 are exposed outside the insulating shell 36. The behavior principle of the probe 3′ shown in FIG. 6 and the probe 3 shown in FIG. 3 are the same and will not be mentioned again here.

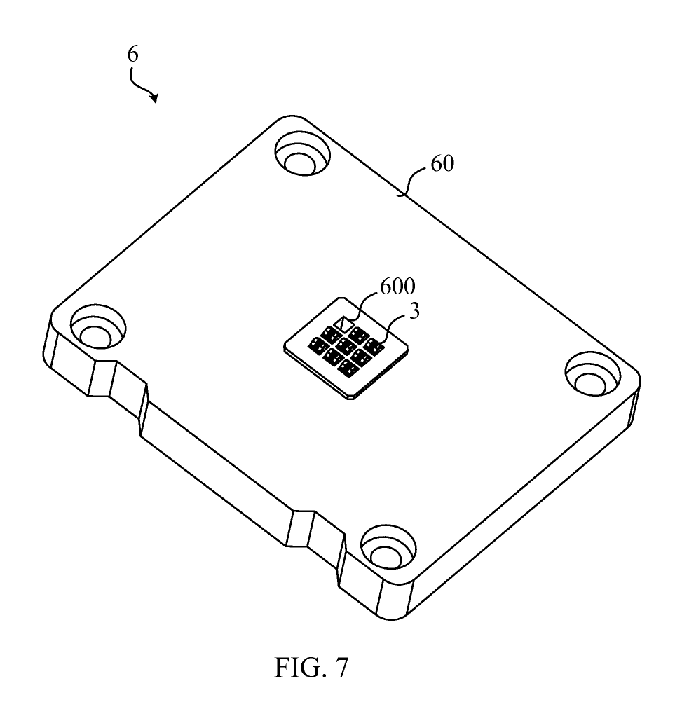

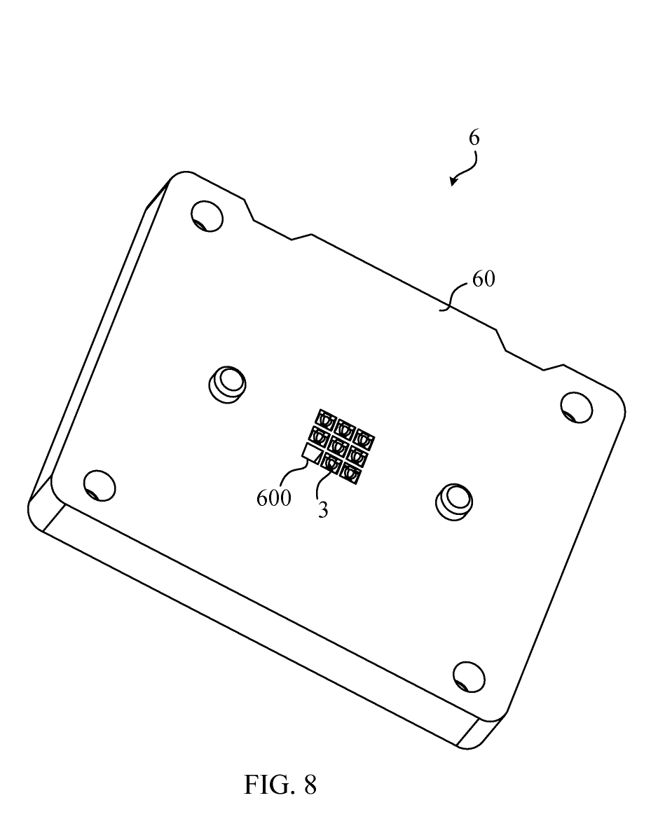

Please refer to FIG. 7 and FIG. 8. FIG. 7 is an appearance view illustrating a connecting device 6 which utilizes the probe 3 shown in FIG. 3; FIG. 8 is a rear view illustrating a connecting device 6 shown in FIG. 7. A base 60 of the connecting device 6 has a plurality of holes 600. Each probe 3 is respectively disposed in the corresponding hole 600. In other words, the probe 3 can be directly assembled in the corresponding hole 600 of the connecting device 6, and the insulating shell 36 shown in FIG. 6 is not required.

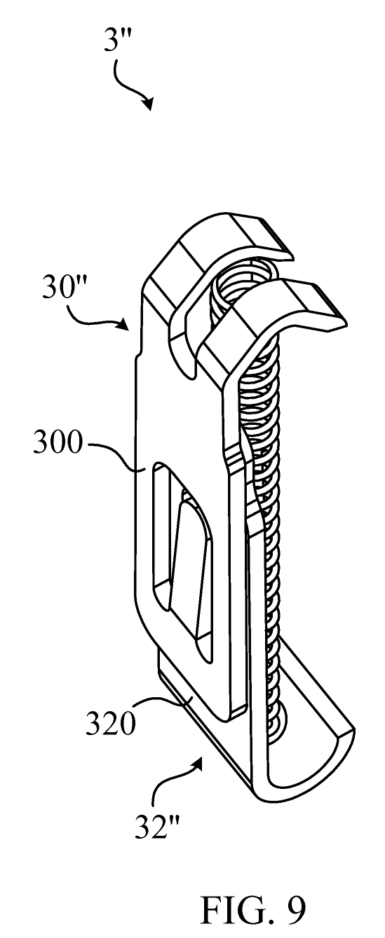

Please refer to FIG. 9. FIG. 9 is an appearance view illustrating a probe 3″ according to another embodiment of the invention. The main difference between the probe 3″ and the probe 3 is that a terminal 30″ has only a connecting portion 300, and a terminal 32″ has only a connecting portion 320. The behavior principle of the probe 3″ shown in FIG. 9 and the probe 3 shown in FIG. 3 are the same and therefore will not be mentioned again here.

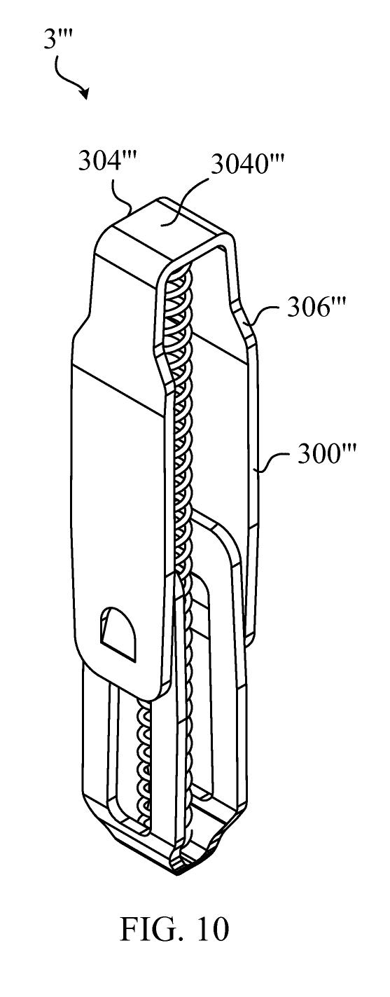

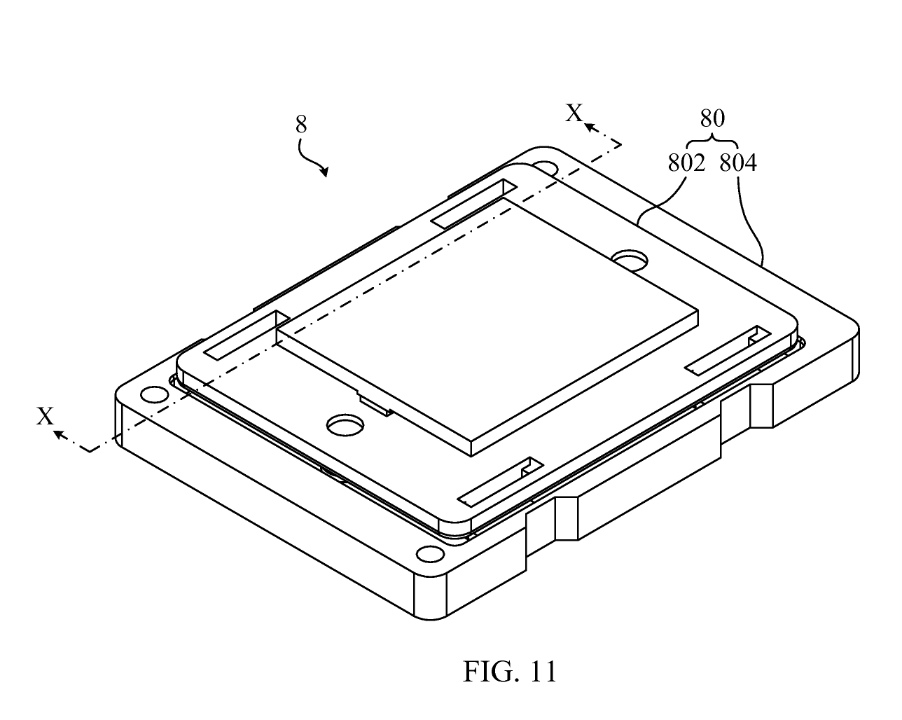

Please refer to FIG. 10. FIG. 10 is an appearance view illustrating a probe 3′″ according to another embodiment of the invention. The main difference between the probe 3′″ and the probe 3 is that a contact portion 304′″ has a rough surface 3040′″, and there is a neck 306′″ between a connecting portion 300′″ and a contact portion 304′″. The behavior principle of the probe 3′″ shown in FIG. 10 and the probe 3 shown in FIG. 3 are the same and will not be mentioned again here.

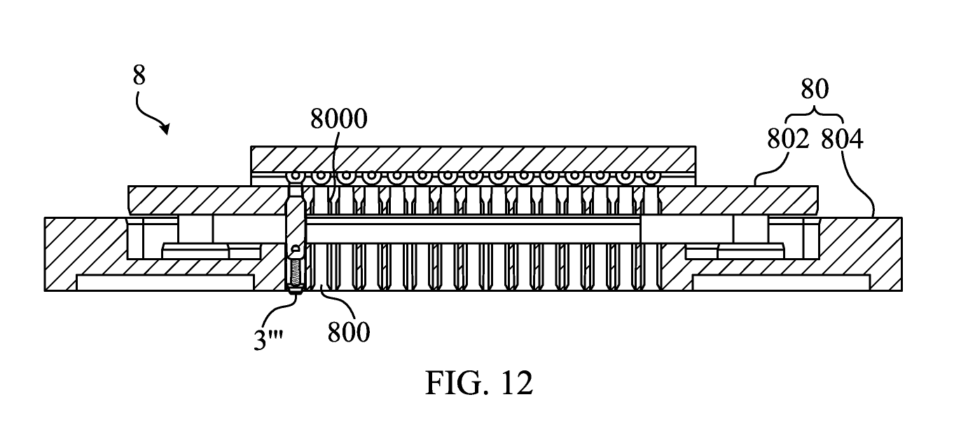

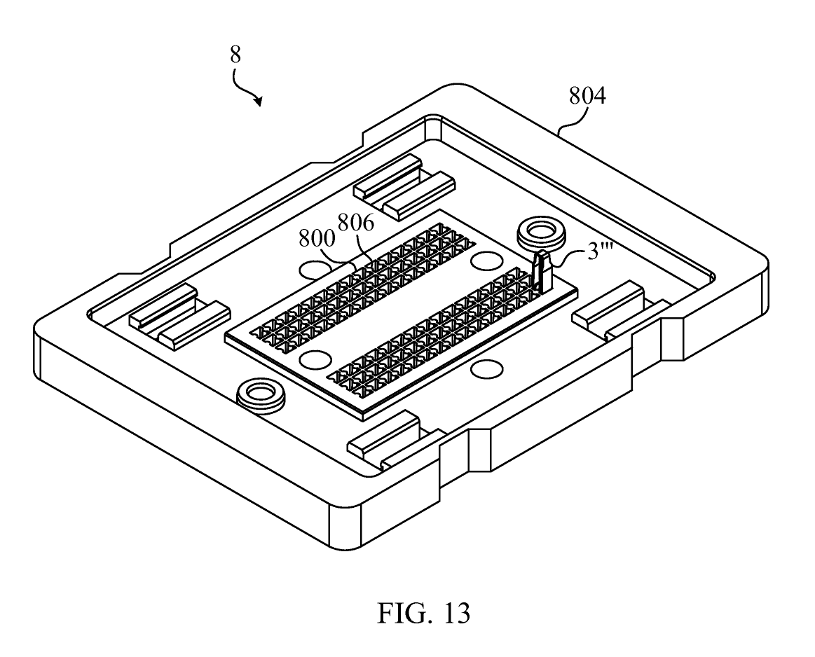

Please refer to FIG. 11 through FIG. 13. FIG. 11 is an appearance view illustrating a connecting device 8 which utilizes the probe 3′″ shown in FIG. 10. FIG. 12 is a cross-sectional view illustrating a connecting device 8 along line X-X shown in FIG. 11. FIG. 13 is an appearance view illustrating a connecting device 8 which removes a first housing 802 shown in FIG. 11. A base 80 of the connecting device 8 comprises the first housing 802 and a second housing 804, a plurality of first holes 800 penetrate the first housing 802 and the second housing 804. Each probe 3′″ is respectively disposed in the corresponding first hole 800. Each first hole 800 has a shoulder 8000, the probe 3′″ leans on the shoulder 8000 through the neck 306′″ and is to be disposed in the first hole 800.

Furthermore, as shown in FIG. 13, at least one rib 806 is formed in the first hole 800. When the probe 3′″ is disposed in the corresponding first hole 800, the rib 806 can prevent the resilient member from shaking.

Compared with prior art, the probe of the invention is not only simpler to manufacture and lower in cost. Furthermore, the terminal has lateral resilience after bending, so it will be easier to be assembled. Accordingly, the probe can be directly assembled in the corresponding hole of the connecting device, and the insulating shell is not required.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A probe, comprising:
a first terminal comprising at least one first connecting portion, a first contact portion and a first stop portion;
a second terminal comprising at least one second connecting portion, a second contact portion and a second stop portion, with the first stop portion being configured in the second stop portion; and
a resilient member disposed between the first contact portion and the second contact portion;
wherein when the first contact portion of the first terminal or the second contact portion of the second terminal is compressed, the first stop portion of the first terminal moves with respect to the second stop portion of the second terminal.

2. The probe of claim 1, wherein the first stop portion of the first terminal is formed on the first connecting portion.

3. The probe of claim 1, wherein the second stop portion of the second terminal is formed on the second connecting portion.

4. The probe of claim 1, wherein the first contact portion has an opening.

5. The probe of claim 1, wherein the first contact portion has a rough surface.

6. The probe of claim 1, wherein there is a neck between the first connecting portion and the first contact portion.

7. The probe of claim 1, wherein the second contact portion has a protrusion.

8. The probe of claim 1, wherein the resilient member is a spring.

9. The probe of claim 1, further comprising an insulating shell for accommodating the first terminal, the second terminal and the resilient member, the first contact portion and the second contact portion being exposed outside the insulating shell.

10. The probe of claim 1, wherein the first connecting portion is plate-shaped.

11. The probe of claim 1, wherein the second connecting portion is plate-shaped.

12. A connecting device, comprising:
a base having a plurality of first holes;
at least one probe, each probe is part-slidingly disposed in the corresponding first hole respectively, each probe respectively comprising a first terminal, a second terminal and a resilient member, the first terminal comprising at least one first connecting portion and a first contact portion, the first connecting portion having a first stop portion for limiting the first connecting portion, the second terminal comprising at least one second connecting portion and a second contact portion, the second connecting portion having a second stop portion for limiting the second connecting portion, the resilient member being disposed between the first contact portion and the second contact portion.

13. The connecting device of claim 12, wherein the first stop portion is configured in the second stop portion, when the first contact portion or the second contact portion is compressed, the first stop portion moves with respect to the second stop portion.

14. The connecting device of claim 12, wherein the first contact portion has an opening.

15. The connecting device of claim 12, wherein the first contact portion has a rough surface.

16. The connecting device of claim 12, wherein there is a neck between the first connecting portion and the first contact portion.

17. The connecting device of claim 16, wherein the first hole has a shoulder, the probe leans on the shoulder through the neck to be disposed in the first hole.

18. The connecting device of claim 12, wherein the second contact portion has a protrusion.

19. The connecting device of claim 12, wherein the resilient member is a spring.

20. The connecting device of claim 12, wherein the first connecting portion is plate-shaped.

21. The connecting device of claim 12, wherein the second connecting portion is plate-shaped.

22. The connecting device of claim 12, wherein the base comprises a first housing and a second housing, the first hole penetrates the first housing and the second housing.

23. The connecting device of claim 12, wherein at least one rib is formed in the first hole.
